(19) United States
(12) Patent Application Publication
(10) Pub. No.: US 2023/0326266 A1
(43) Pub. Date: Oct. 12, 2023

(54) VEHICLE FEATURE ORCHESTRATOR

(71) Applicant: FORD GLOBAL TECHNOLOGIES, LLC, Dearborn, MI (US)

(72) Inventors: Medha Karkare, Canton, MI (US); Akash Agarwal, Santa Clara, CA (US); Robert Parenti, Dearborn, MI (US); Ali Hassani, Ann Arbor, MI (US); Faizan Shaik, Farmington Hills, MI (US)

(21) Appl. No.: 17/717,497

(22) Filed: Apr. 11, 2022

(51) Int. Cl. G07C 5/08; G07C 5/00; G06F 9/4401

(52) U.S. Cl. CPC G07C 5/0816; G07C 5/004; G06F 9/442

(57) ABSTRACT

A system receives a request to engage one or more vehicle micro-services on behalf of a vehicle feature. The system accesses a manifest associated with the vehicle feature, the manifest including the one or more micro-services and configurations to be associated with instances of the one or more micro-services launched on behalf of the vehicle feature. The system requests launch of each of the micro-services and the associated configurations from a vehicle process responsible for micro-service launch, to build a pipeline for the vehicle feature and translates results generated by at least one micro-service of the pipeline into a format predefined as suitable for use by the vehicle feature.

### TECHNICAL FIELD

The illustrative embodiments generally relate to methods and apparatuses for a vehicle feature orchestrator.

### BACKGROUND

Vision applications and artificial intelligence/machine learning (AI/ML) applications provide a good foundation for smart vehicle features but can be computationally heavy. Running these services provides an excellent consumer experience based on the services, but can detract from the consumer experience if the services excessively tax power and compute resources, by diminishing capability and range of vehicles, especially electric vehicles with regards to power usage.

As vehicle functions and features grow more advanced, there will be increasing demand for AI/ML application support, leveraging vehicle sensors and vehicle data and performing potentially computationally intensive tasks in concert or successively. Having too many services executing can diminish compute resources, delay system responsivity and drain power from vehicle power sources. Not having the services execute in a timely manner can render the customer confused and believing that their vehicle is malfunctioning or inferior to other vehicles, or to what was promised as a user experience.

People are often not going to be aware of the computationally intensive nature of requested features, instead simply expecting them to run on demand and installing and using them as desired, without considering the impact on overall vehicle state. Meeting the expectations of the consumer without excuse and managing vehicle resources to meet those expectations is a difficult task and will frequently fall on the underlying system.

### SUMMARY

In a first illustrative embodiment, a system includes a processor configured to receive a request to engage one or more vehicle micro-services on behalf of a vehicle feature. The processor is also configured to access a manifest associated with the vehicle feature, the manifest including the one or more micro-services and configurations to be associated with instances of the one or more micro-services launched on behalf of the vehicle feature. The processor is further configured to request launch of each of the micro-services and the associated configurations from a vehicle process responsible for micro-service launch, to build a pipeline for the vehicle feature and translate results generated by at least one micro-service of the pipeline into a format predefined as suitable for use by the vehicle feature.

In a second illustrative embodiment, a method includes receiving a request to engage one or more vehicle micro-services on behalf of a vehicle feature. The method also includes accessing a manifest associated with the vehicle feature, the manifest including the one or more micro-services and configurations to be associated with instances of the one or more micro-services launched on behalf of the vehicle feature. The method further includes requesting launch of each of the micro-services and the associated configurations from a vehicle process responsible for micro-service launch and vehicle resource management, to build a pipeline for the vehicle feature and translating results generated by at least one micro-service of the pipeline into a format predefined as suitable for use by the vehicle feature.

In a third illustrative embodiment, a non-transitory storage medium storing instructions that, when executed, cause a vehicle processor to perform a method including receiving a request to engage one or more vehicle micro-services on behalf of a vehicle feature. The method also includes accessing a manifest associated with the vehicle feature, the manifest including the one or more micro-services and configurations to be associated with instances of the one or more micro-services launched on behalf of the vehicle feature. The method further includes requesting launch of each of the micro-services and the associated configurations from a vehicle process responsible for micro-service launch and vehicle resource management, to build a pipeline for the vehicle feature and translating results generated by at least one micro-service of the pipeline into a format predefined as suitable for use by the vehicle feature.

### BRIEF DESCRIPTION OF THE DRAWINGS

FIG. 1 shows an illustrative example of biometric services system;

FIG. 2 shows an illustrative example of a services wrapper;

FIG. 3 shows an illustrative example of a micro-service execution management process;

FIG. 4 shows an illustrative example of service request handling;

FIG. 5 shows an illustrative example of service termination;

FIG. 6 shows an illustrative example of feature brokering; and

FIG. 7 shows an illustrative example of result translation.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Vehicles may include fully networked vehicles such as vehicles with both internal and external communication. Internal communication can be achieved by short-range and long-range wireless communication as well as wired communication through a vehicle bus, e.g. a control area network (CAN) bus and/or other data connections. External connections can include wireless connections to, for example, other vehicles (V2V), infrastructure (V2I), edge processors (V2E), mobile and other devices (V2D), and the cloud (V2C) through cellular or other wireless connectivity. Collectively these connections may be referred to as V2X communications, wherein X is any entity with which a vehicle is capable of communication. These vehicles may include distributed processing onboard, the capability of leveraging edge and cloud processing, and specialized architecture that can be repurposed for the purpose of providing highly advanced computing services under at least certain circumstances.

Vehicles may also include software and firmware modules, and vehicle electronic control units (ECUs) may further include onboard processing. Vehicle features may include artificial intelligence and machine learning models that may provide advanced occupant services leveraging vehicle sensors and shared cloud data. The AI/ML models may be capable of self-advancement (online in-vehicle learning) to tune the models to a vehicle context and user preferred experience. Sensors may include, but are not limited to, cameras, LIDAR, RADAR, RFID, NFC, suspension sensing, occupant sensors, occupant identification, device sensing, etc.

Vehicle features can leverage sensor data and other vehicle data to provide on-demand feature support as required by a feature. This data may be fed into complex AI/ML processes that utilize significant compute power, at least momentarily, while they provide the necessary inferences and output for the requesting feature. Keeping the services running after the immediate need may be inefficient, and yet multiple features may rely on a service, so it is not simply enough to always terminate all feature-required services once the feature has the data it requires. Further, vehicle resources may be taxed to a point where certain services cannot co-function, or at least in a reasonable and expected manner, and so resource prioritization may be required. Users may also not be aware of a depletion of power reserves in response to over-use of features, and this consideration may be managed automatically as well, to avoid leaving the user well under and expected range and possibly stranded.

The illustrative embodiments propose a service execution manager that intelligently manages vehicle micro-services such as independent processes and threads. One or more feature orchestrators may act as a pipeline builder and service liaison. An orchestrator may receive service requests and broker them. The execution manager may received brokered requests from the orchestrator and manage the services required to build a pipeline (which can be done by the orchestrator) that services the originally-requesting feature. The manager can launch configured services, correctly configured for an application, track use to eliminate redundancy, safely spin down services (and clean up dynamic memory), and monitor overall status for functional safety. Once a pipeline is built pursuant to a brokered request, the orchestrator can serve as a liaison between the pipeline and a consumer-facing service, including translating messaging into appropriate protocol(s) (e.g., Adaptive AUTOSAR).

Acting in concert, the orchestrator and execution manager can manage vehicle resources efficiently, prevent overtaxing computer or power resources, build and disassemble service pipelines and provide communication translation so that information can flow between disparate entities.

The execution manager may manage vehicle services such as vision services and AI/ML services. It may receive requires from the feature orchestrator to manage the services required for a given pipeline. Based on available resources, the execution manager may, for example, start, modify or stop desired micro-services and implement necessary configurations of services as applicable for a given request.

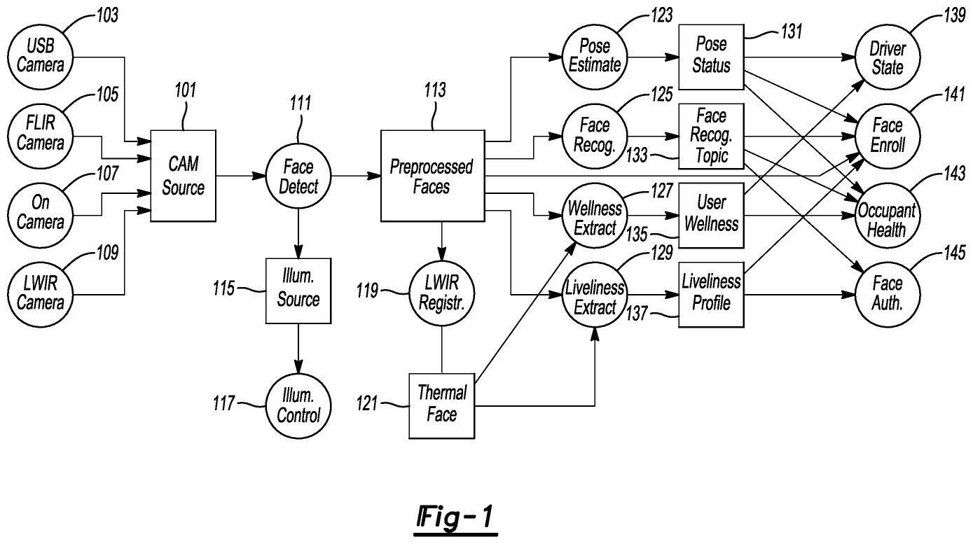

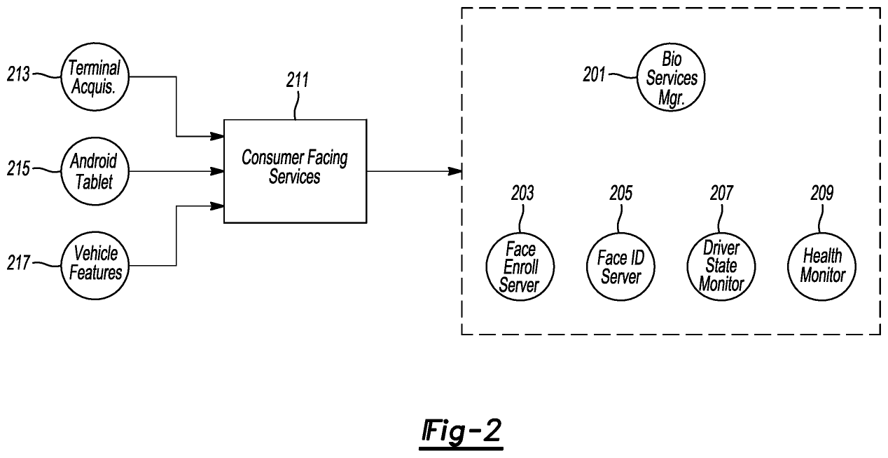

FIG. 1 shows an illustrative example of biometric services system. In this example an operating system may parallelize services for camera acquisition, image processing, facial feature extraction/inference, and communication to a vehicle bus for feature actuation. FIG. 2 shows an illustrative example of a services wrapper, wherein a bio services manager 201 acts as a real time supervisor, controlling the states of the services.

A sensing framework may provide inputs via, for example, USB camera 103, FUR camera 105, ON camera 107 and long-wave infrared (LWIR) camera 109. Any of this data may be fed into a cam source topic 101, which passes the data to face detection and pre-processing process 111 which may subscribe to the cam source topic 101 for data. Face detection and preprocessing may pass information to an illumination source topic 115, to which an illumination controller 117 may subscribe. If alterations to illumination are needed in order to detect or pre-process a facial image, for example, the illumination controller may handle this based on data published to the illum source topic 115. The detection and preprocessing 111 may publish, for example, a face ID, a cropped face with other irrelevant image data removed or trimmed, landmarks for the face, ambient light conditions, an occupant location, which camera was used to gather an image, etc.

Output from the facial detection and pre-processing 111 may be published to a preprocessed faces and landmarks topic 113. In this example, several AI/ML processes subscribe to this topic to provide input for the processes, and a secondary vision processing process LWIR registration 119 may also subscribe to this topic. LWIR processing may process information when it is gathered at least by the LWIR camera, which can include out to a thermal face topic. Output to this topic can include, for example, a thermal mask of a face and/or an occupant location.

The four illustrative AI/ML processes shown include pose estimation 123, face recognition 125, wellness feature extraction 127 and liveliness feature extraction 129. One or more of each of these AI/ML processes may be required or desired to produce data for use by the various features 139, 141, 143, 145. In this example, all four processes 123, 125, 127, 129 support one or more features 139, 141, 143, 145, but none support all features. It may also be computationally expensive to run all four processes concurrently, and yet each provides some useful data to one or more features.

Requests from terminal acquisition 213, a tablet 215 or activated vehicle features 217 may be published to a consumer facing services topic which is subscribed to by the wrapper including the supervisor 201 and servers 203, 205, 207, 209 for each feature 139, 141, 143, 145. The bio-services manager 201 (supervisor) will determine which requests can be handled in what order based on available resources. Certain requests may have priority, for example, if an authentication process 145 is needed to start the vehicle, then the services 123, 125, 129 to support that process may be added to the pipeline.

Each service 123, 125, 127, 129 may publish data to a respective topic 131, 133, 135, 137. For example, in this instance pose estimation 123 may publish data to pose states topic 131, which can include pose state and occupant location, among other things. Face recognition 125 may publish to a face recognition topic, with information such as a face recognition ID, a face detection ID (from preprocessing 111) and an occupant location, among other things. Wellness feature extraction 127 may publish to user wellness topic 135, with a face ID, occupant location and wellness state. Liveliness feature extraction 129 may publish to liveliness profile 137 with a liveliness mask and liveliness pixels.

At the authentication phase, Face Authentication logic 145 subscribes to pose states 131, face recognition 133, and liveliness 137 and produces, among other things, authentication approval or rejection. That output can be translated and sent back to a requesting entity 213, 215, 217. Then, for example, if face enrollment 141 is not planned, there is no other feature logic that subscribes to the liveliness profile topic, and since authentication has already occurred, the feature extraction process 129 may be spun down. If only a driver-state monitoring request remains in the consumer facing services topic 211, then the supervisor 201 may also spin down face recognition 125 and spin up pose estimation 123 for addition to the pipeline, as the driver state monitoring logic subscribes to two topics, the user wellness topic, which already is supported by service 127 launched for face authentication 145 and pose states 131, which would be supported by the newly launched pose estimation service 123.

By efficiently ordering and handling the requests and recognizing the required underlying services and spinning them up or down as needed, the supervisor can keep compute utilization within define thresholds and keep power draw and reserves at an acceptable level.

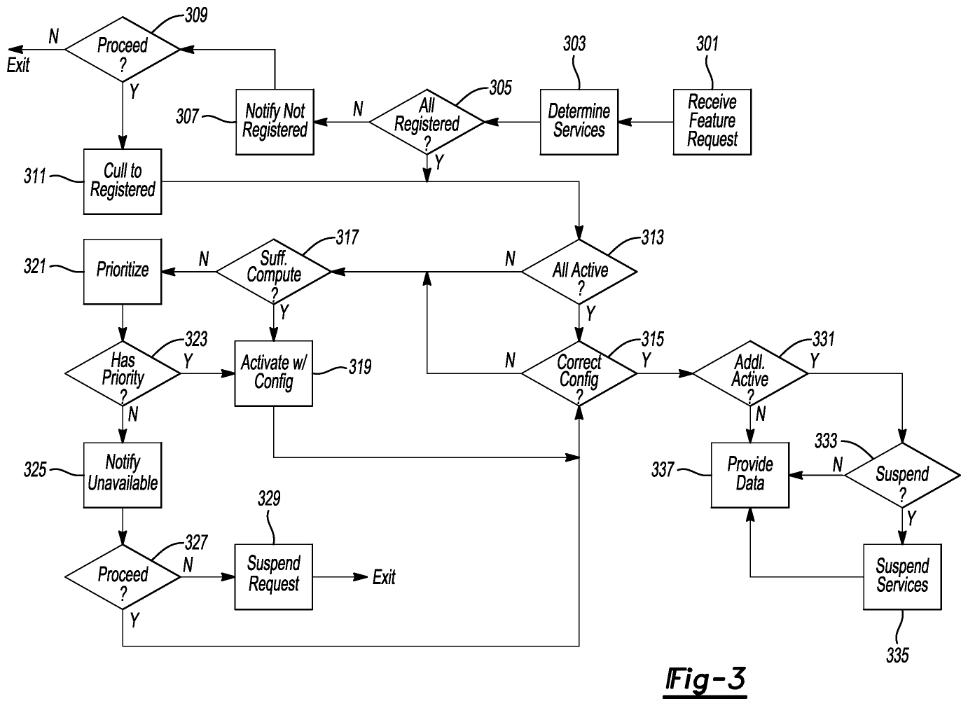

FIG. 3 shows an illustrative example of a micro-service execution management process. A feature may request or require one or more micro-services based on a feature request at 301. The orchestrator can determine and request the necessary micro-services at 303. When the execution manager receives a new micro-service initialization request, it may perform a series of resource checks to determine viability of launching the service. This can include, for example, determining if the micro-services are all registered with the platform manifest at 305. If a micro-service is not registered, the execution manager may notify the orchestrator at 307 and the orchestrator and/or feature can determine whether it can proceed 309 in the absence of the data provided by the unregistered micro-service (e.g., a “lite” version of the feature may be possible). If the feature/orchestrator still wants to proceed, the micro-services request is pared back to the registered micro-services at 311.

The execution manager may also determine if all of the requested services are currently active at 313. Each micro-service may have multiple configurations, so simply because a micro-service is currently active does not mean that instantiation is configured correctly for the new request. When configurations conflict, the execution manager may need to either initialize both variants independently (two instances of the micro-service) or, if resources are constrained, modify the existing service's configurations to support all non-conflicting configurations.

When a service is not currently active at 313 and/or when a current configuration of an active service is not the required configuration at 315, the execution manager may have to consider available compute (or other) resources (e.g., power) at 317. If there are sufficient resources, the execution manager can activate a second instance of the micro-service with the correct new configuration at 319. If there is insufficient compute or other resources remaining, the execution manager may determine if the current request has priority over a feature being served by the currently executing, but improperly configured for the current request, instance of the micro-service at 321.

That is, compute resources, for example, may limit the execution manager to one instance of a micro-service. If the current request has priority at 323 over an existing request being serviced by the existing instance of the micro-service, then the execution manager may have to either reconfigure the existing micro-service to service the new request or spin down the existing micro-service and spin up a new instance configured for the current, priority request. That may also result in termination of a prior feature being supported by the now reconfigured or spun down micro-service, which can be handled by the orchestrator in response to being notified of the above change.

If the prior request and existing version of the micro-service has priority, and the resources are constrained, the execution manager may notify the orchestrator that the service is unavailable at 325. The orchestrator or feature may still be able to proceed at 327 without the micro-service (e.g., “lite” version), or the execution manager may queue the request for later handling when the resource situation changes. Additionally or alternatively, the execution manager may notify the orchestrator when the resource situation changes, so that the feature can resubmit the request if it is still desired.

It may also be the case that the execution manager has additional micro-services enabled when a new priority request or non-priority request occurs. For resource management reasons, among other things, the execution manager may determine what additional micro-services are currently running that may not be needed by the present feature request at 331. If there are no ancillary services at 331, the requested micro-service may execute and publish or provide the requested data at 337. If there are additional services and resources are sufficient to support those services at 333, the data provision may also occur.

If there are additional micro-services executing and resources are running low, or if those services are no longer needed and simply have not yet been terminated, the execution manager may suspend the service at 335. When a feature has completed its need for a given micro-service, the execution manager may receive a suspension request from the orchestrator. This can be verified against a lookup table, for example, to ensure that no other features are currently using the service. When resources constrain co-executing services, the priority of each feature using each service may be considered to determine a corresponding priority of a given micro-service. Then, based on priority and/or any other desired factors, certain micro-services may also be suspended. This may result in notification to the orchestrator that certain other features may not be supported because a service is being suspended for priority reasons.

When suspending a service, the execution manager may perform a graceful shutdown that includes clean up of all dynamic memory, pointers, etc. If this fails, the micro-service may be simply terminated regardless of state. Because compute resources may be scant and a high-priority request may occur, the execution manager can use termination as a resort in order to expedite free-up of compute resources.

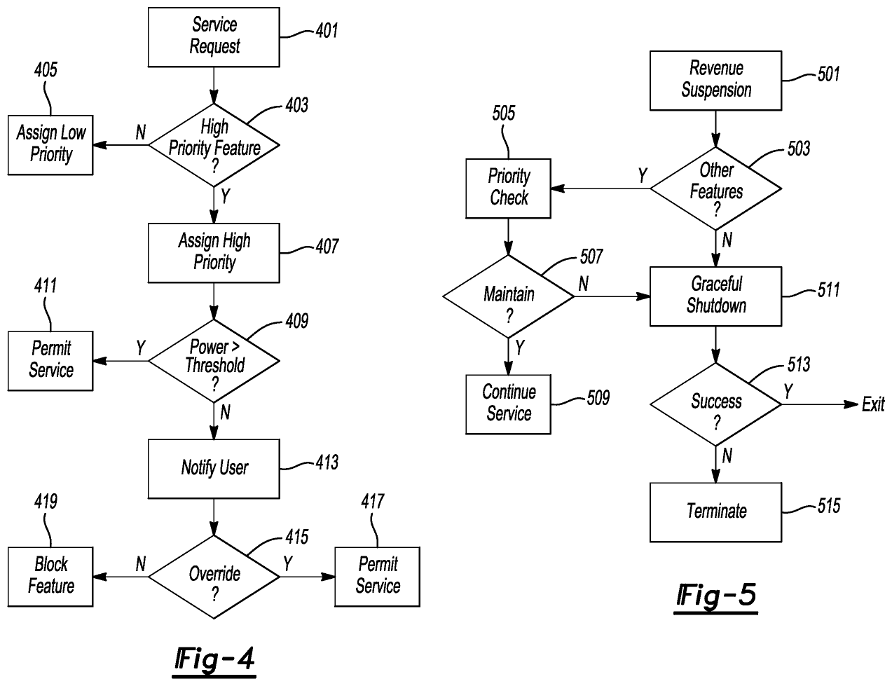

FIG. 4 shows an illustrative example of service request handling. In this example, the execution manager both considers the priority of a service and provides an override option for a user. While the override is not necessary, a micro-service that is denied because, for example, it may reduce a vehicle range based on power usage, may instead be launched by the user because the user knows they are about to park and charge the vehicle for eight hours. In that instance, the user knows something the vehicle may not know and therefore is in a position to make an alternative decision. If the vehicle knows the destination and whether charging commonly occurs (information that can be modeled off of historic data), the vehicle may accommodate this in the power considerations and either ignore a power requirement that preserves battery life if charging is highly likely in short order (e.g., X %+likely) and/or inform the user about the impending power usage and just ask for a confirmation that charging will soon occur.

In general, service priorities can be dynamically managed based on power state to optimize power resource uses while minimizing latency. This could include, for example, suspending all activities except for primitive detectors (e.g., face or motion detection) and then only activating more computationally heavy services when power allows—e.g., facial recognition may only be engaged when a baseline battery level exists). The decision about allowable power usage may, as previously noted, be based on user input, presently known route data (indicating nearby destinations with charging, for example) and/or historic knowledge about when charging occurs and where, among other things.

The same override concepts could be applied in decisions related to compute limitations, wherein the user may be able to override a “vehicle preferred” service for a service the user prefers. The options here may be fewer, however, because many vehicle services will be mission-critical (e.g., driving related) and/or the user may not understand the implications of disabling one service in favor of another. On the other hand, if the user is driving in a very tired state and the vehicle is attempting to disable driver drowsiness for an alternative, higher priority, but optional, scenario, the user may be able to set a preference for the driver drowsiness detection feature.

In general, service priorities can dynamically change based on feature needs as well (in addition to user-defined priorities that do not violate any safety-paradigms the user may not understand). For example, facial recognition may be a high priority service when biometric access and start is engaged (since the face is the key to the vehicle) but may be a low priority service when only used for cabin monitoring and occupant location tracking. The service manager may have the capacity to intelligently manage service priorities, e.g., through a lookup table or intelligent agent. User indicated preferences such as the preceding may be used to monitor and adapt to historic behavior, such as increasing health monitoring priority during flu season or increasing driver drowsiness when the vehicle is driven after a certain hour of the day, especially, in either instance, if the user has indicated a personal preference for the same. Thus, context associated with the vehicle (vehicle states, environmental contexts, location of the vehicle, power states, etc.) may be used to dynamically vary the priorities under a currently-applicable one or more contexts.

In the example shown in FIG. 4, the execution manager receives a request for a micro-service from the orchestrator at 401 and determines whether the feature is a high priority feature at 403. If not, the service is assigned a low priority at 405, which could be a function of what feature priority is assigned based on vehicle state or generally applies to a feature. If the feature is high priority at 403, then the service is assigned a high priority at 407. It is worth noting that priorities can include more than a binary system of high and low, and can include weighting based on situations, user preferences, etc., to develop a complex and adaptive priority system that can reweight priorities reactive to virtually any situation. Some features may always be considered high-priority in certain embodiments, but many features may be more likely thought of as being situationally high/low priority. If the service is high priority and power (or another constraint) is above a threshold at 409, the service is permitted at 411. A low priority service may also be permitted under a similar consideration but may also require consideration of what higher priority services are running.

If the power is at an insufficient level to permit the service, the process may notify the user at 413. Why the power is insufficient may also be considered, which may be a different consideration for overtaxing net power supply as opposed to draining remaining resources. If heat generation or other potential malfunction due to overuse of power at one time is the concern, the user may not be able to override the rejection of the service, but if the power consideration is one of reserves-remaining, then the user may be able to override, potentially having more complete information than the vehicle does about when charging will next occur. Notification can include identification of projected power usage, effect on range, and any other data or considerations that may be relevant to the user before the user makes a decision.

If the user elects to override the decision to block the service at 415, the service is permitted at 417 and the feature can be utilized. Otherwise, the process, at least temporarily, blocks the feature or service at 419 to preserve power resources. When an overridden service is executing, it may also be possible to provide a user with active feedback on power reserves, in case the drain is more than expected or the user needs to skip charging (e.g., gets an emergency phone call and has to reroute). The user may thus be provided with data and a termination button related to any service for which override is provided (or otherwise). In at least one example, a user could access a vehicle menu showing all active services, power drains and estimated effect on power reserves, for example, in case of the preceding situation or another situation in which the user anticipates a long delay of which the vehicle might not be aware. Thus, it may be possible to give the user some direct, active control over the termination of some or all services if desired, along with information about resource usage that can inform the decision.

FIG. 5 shows an illustrative example of service termination. This is an example of the graceful shutdown process previously described. In this example, the execution manager receives a suspension request from the orchestrator at 501. The manager checks at 503 if other features are still using the service (e.g., based on a lookup table). If no other features are using the service, the manager attempts a graceful shutdown at 511, wherein the service is terminated, dynamic memory is cleaned up, pointers are cleared, etc. If this is unsuccessful at 513, the manager may simply directly terminate the service at 515.

If other features are still using the service, the manager may perform a priority check at 525 if the service has been reprioritized. That is, the service may have been executing on behalf of a high priority feature and thus been allowed to run, or been executing under user override for a given feature. If that feature is terminated, the service may be reprioritized and may no longer qualify for present execution. If the priority check of the service (which may be based, for example, on what features still use the service) entitles the service to keep executing at 507, the manager may maintain the service at 509. Otherwise, the graceful shutdown may occur.

Feature orchestrators may exist relative to suites of services. When a given consumer service is requested from the platform, it may be registered with a given feature orchestrator. For example, all facial recognition based consumer services may be registered with a face perception orchestrator. The orchestrator may receive service requests from the consumer side and act as a service broker. If a pipeline to support the service can be built, the orchestrator may inform the service of a successful initialization. If the pipeline cannot be built, the orchestrator can reject the request and may provide debugging information if desired (resource constraints, service not recognized, etc.).

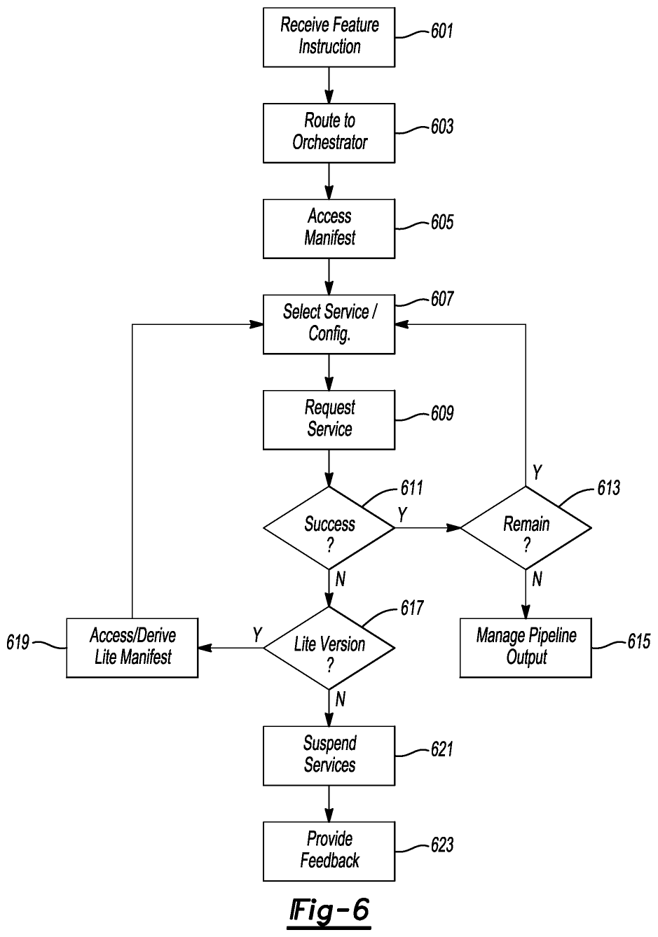

FIG. 6 shows an illustrative example of feature brokering. A feature request may be received from the intelligent services platform at 601 and registered with the feature orchestrator at 603. The orchestrator accesses a manifest associated with the requested feature at 605. The manifest dictates the services and configurations necessary for the requested feature. The orchestrator uses the manifest to request the appropriate services and configurations from the execution manager.

For example, from a list of services required for the requested feature, the orchestrator selects a given service and configuration at 607 and requests the service and configuration from the execution manager. The service and correct configuration may also be running on behalf of another feature, so in that instance the feature orchestrator can provide access to that already-executing service on behalf of the newly requested feature (add it to the pipeline). If either instance is shut down, the service may still remain active if it is used by the other feature, unless there are resource constraints and the remaining feature fails a priority test or other criteria for mandatory shutdown.

If the launch of the service is successful at 611, the orchestrator determines if more services need launch and configuration at 613. If not, the pipeline is completed and the requested feature is informed by the orchestrator of successful initialization. If a given service cannot be launched, the orchestrator may determine at 617 if there is a “lite” version of the feature available. This could be indicated in the manifest or a request for the feature that correlates to a second manifest. The lite version may require fewer computationally heavy resources and may provide necessary functionality for at least certain tasks associated with the feature as discussed above. If there is a lite version the orchestrator may access a new manifest at 619 or the current manifest may have services required and configurations for both.

It is possible that the lite version still requires a service that cannot be launched, and so in that instance the orchestrator would branch at 617 to the same result as though there were no lite version, which would be to suspend the already-requested services at 621. The suspension request will result in graceful shutdown of any executing services, except to the extent that they are used by other active features, which would presumably be known to the orchestrator or execution manager. Since there may be more than one orchestrator, e.g., an orchestrator for groups of features related to certain general functions such as facial recognition, the execution manager may be best positioned to ensure a given service is not executing on behalf of another feature, although either the orchestrator or manager could determine this information through a lookup or similar determination. The orchestrator may also provide any feedback to the requesting entity at 623, such as service not registered, insufficient resources, insufficient power, etc.) Certain conditions, such as insufficient power, as described above, may provide the user with an opportunity to override the decision not to launch the service. As previously noted, the override option may also provide information about how much power is projected to be used and the projected impact on vehicle performance.

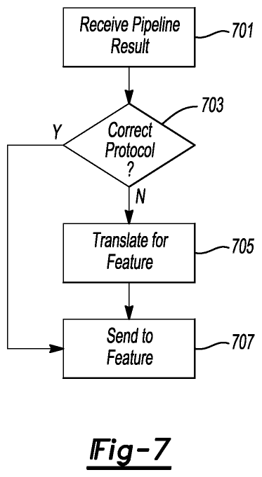

FIG. 7 shows an illustrative example of result translation. The orchestrator also acts as a communication liaison for consumer facing services. Internal pipeline communication may not be compliant with an industry standard for application-facing communication (e.g., AUTOSAR). To allow developers to create applications that can work across multiple OEMs and vehicle platforms, standard communication protocol may be used when communicating with an external service.

The orchestrator may receive a result from a service or services executing on the pipeline at 701. The orchestrator may determine at 703 if the result is formatted in a compliant and appropriate communication protocol and, if not, translate the result at 705 into the correct protocol. Then the orchestrator can send the translated result to the feature at 707.

The illustrative embodiments provide improved handling of multiple potentially high-compute/high-power features that use AI and ML processes and which, when improperly managed, could severely overtax limited vehicle resources to the detriment of a user. Each playing a role, the execution manager and feature orchestrator individually and collectively work to allow provision of a robust suite of services while keeping computational footprint under control and contemplating overall available vehicle resources and the impact of feature-usage thereon.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
a vehicle processor configured to:
receive a request to engage one or more vehicle micro-services on behalf of a vehicle feature;
access a manifest associated with the vehicle feature, the manifest including the one or more micro-services and configurations to be associated with instances of the one or more micro-services launched on behalf of the vehicle feature;
request launch of each of the micro-services and the associated configurations from a vehicle process responsible for micro-service launch, to build a pipeline for the vehicle feature; and
translate results generated by at least one micro-service of the pipeline into a format predefined as suitable for use by the vehicle feature.

2. The system of claim 1, wherein the vehicle process responsible for micro-service launch is further responsible for vehicle resource management.

3. The system of claim 1, wherein the processor is further configured to:
determine whether a given of the micro-services was not successfully launched, based on responses received from the vehicle process and responsively:
request shutdown of all of the micro-services previously launched; and
cease requests for remaining of the micro-services.

4. The system of claim 3, wherein the processor is further configured to notify the vehicle feature of an unsuccessful pipeline build, responsive to determining that the given of the micro-services was not successfully launched.

5. The system of claim 4, wherein the processor is further configured to include debug information in the notification.

6. The system of claim 5, wherein the debug information includes at least one reason the given of the micro-services was not successfully launched.

7. The system of claim 6, wherein the at least one reason includes insufficient compute resources.

8. The system of claim 6, wherein the at least one reason includes insufficient power resources.

9. The system of claim 1, wherein the processor is further configured to:
receive indication that the vehicle feature is terminating; and
responsively request suspension of the pipeline from the vehicle process responsible for execution management.

10. A method comprising:
receiving a request to engage one or more vehicle micro-services on behalf of a vehicle feature;
accessing a manifest associated with the vehicle feature, the manifest including the one or more micro-services and configurations to be associated with instances of the one or more micro-services launched on behalf of the vehicle feature;
requesting launch of each of the micro-services and the associated configurations from a vehicle process responsible for micro-service launch and vehicle resource management, to build a pipeline for the vehicle feature; and
translating results generated by at least one micro-service of the pipeline into a format predefined as suitable for use by the vehicle feature.

11. The method of claim 10, further comprising determining whether a given of the micro-services was not successfully launched, based on responses received from the vehicle process and responsively:
requesting shutdown of all of the micro-services previously launched; and
ceasing requests for remaining of the micro-services.

12. The method of claim 11, further comprising notifying the vehicle feature of an unsuccessful pipeline build, responsive to determining that the given of the micro-services was not successfully launched.

13. The method of claim 12, further comprising including debug information in the notification.

14. The method of claim 13, wherein the debug information includes at least one reason the given of the micro-services was not successfully launched.

15. The method of claim 14, wherein the at least one reason includes insufficient compute resources.

16. The method of claim 14, wherein the at least one reason includes insufficient power resources.

17. The method of claim 10, further comprising:
receiving indication that the vehicle feature is terminating; and
responsively requesting suspension of the pipeline from the vehicle process responsible for execution management.

18. A non-transitory storage medium storing instructions that, when executed, cause a vehicle processor to perform a method comprising:
receiving a request to engage one or more vehicle micro-services on behalf of a vehicle feature;
accessing a manifest associated with the vehicle feature, the manifest including the one or more micro-services and configurations to be associated with instances of the one or more micro-services launched on behalf of the vehicle feature;
requesting launch of each of the micro-services and the associated configurations from a vehicle process responsible for micro-service launch and vehicle resource management, to build a pipeline for the vehicle feature; and
translating results generated by at least one micro-service of the pipeline into a format predefined as suitable for use by the vehicle feature.

19. The storage medium of claim 18, the method further comprising determining whether a given of the micro-services was not successfully launched, based on responses received from the vehicle process and responsively:
requesting shutdown of all of the micro-services previously launched; and
ceasing requests for remaining of the micro-services.

20. The storage medium of claim 18, the method further comprising:
receiving indication that the vehicle feature is terminating; and
responsively requesting suspension of the pipeline from the vehicle process responsible for execution management.
